(19) United States
(12) Patent Application Publication
(10) Pub. No.: US 2025/0042017 A1
(43) Pub. Date: Feb. 6, 2025

(54) EXOSKELETON AND PROCEDURE

(71) Applicant: FESTOOL GMBH, Wendlingen (DE)

(72) Inventors: Johannes LÜGGER, Hamburg (DE); Jan HAMMER, Elchingen (DE); Edwin BUNNIK, Ulm (DE); Bernward OTTEN, Hamburg (DE)

(21) Appl. No.: 18/682,387

(22) PCT Filed: Aug. 12, 2022
(86) PCT No.: PCT/EP2022/072720

§ 371 Date: Feb. 8, 2024

(30) Foreign Application Priority Data
Aug. 13, 2021 (DE) 10 2021 208 907.0

(51) Int. Cl. B25J 9/00; B25J 9/10

(52) U.S. Cl. CPC B25J 9/0006; B25J 9/106; B25J 9/108

(57) ABSTRACT

An exoskeleton including a base section for attachment to a torso of a human body, a support section for supporting an arm of the human body, an actuator device, in particular a pneumatic actuator device, acting on the support section for providing a support force for the arm, and a shoulder joint arrangement via which the support section is movably coupled to the base section. The shoulder joint arrangement includes a lifting pivot bearing, via which the support section is pivotably mounted on the shoulder joint arrangement about a horizontal lifting axis. The shoulder joint arrangement further includes a joint chain which defines a curved movement path for the lifting pivot bearing lying in a particularly horizontal plane relative to the base section.

The invention relates to an exoskeleton comprising: a base section for attachment to a torso of a human body, a support section for supporting an arm of the human body, an actuator device, in particular a pneumatic actuator device, acting on the support section for providing a support force for the arm, and a shoulder joint arrangement, via which the support section is movably coupled to the base section, the shoulder joint arrangement comprising a lifting pivot bearing, via which the support section is mounted on the shoulder joint arrangement so as to be pivotable about a horizontal lifting axis.

Exoskeletons are known from WO2020038850A1, EP3189945A1, U.S. Ser. No. 10/383,785B2, EP2931484B1, WO2017167349A1, EP2858791B1, DE2615209A1 and U.S. Ser. No. 10/918,559B2.

It is an object of the invention to make it easier for the user to work with the exoskeleton, in particular by improving freedom of movement, range of motion and/or wearing comfort.

The object is solved by an exoskeleton according to claim 1. The shoulder joint arrangement of the exoskeleton comprises a joint chain which defines a curved movement path for the lifting pivot bearing relative to the base section. The movement path is expediently in a plane, in particular in a horizontal plane.

By means of the definition of the curved movement path, the user can be provided with a further degree of freedom in addition to the horizontal lifting axis in order to move their arm supported by the support section in space, in particular horizontally. At the same time, the exoskeleton retains the ability to absorb forces in different spatial directions, in particular also forces in horizontal spatial directions, with the support section and transfer them to the base section via the shoulder joint arrangement. For example, in the case of a curved movement path lying in a horizontal plane, forces in all spatial directions that are not parallel to the path direction according to the current path position of the lifting pivot bearing on the curved movement path can be absorbed by the support section and transferred to the base section.

Using the lifting pivot bearing, the user can perform (together with the support section) a lifting movement around the horizontal lifting axis defined by the lifting pivot bearing with their arm attached to the support section. Due to the human anatomy, the human shoulder moves forward during such a lifting movement. In a conventional exoskeleton, this can lead to the horizontal lifting axis and a horizontal shoulder joint axis of the human shoulder deviating significantly from each other, which can restrict the user's freedom of movement, range of motion and/or wearing comfort. By defining the curved movement path, it can be achieved in particular that during the lifting movement the lifting pivot bearing—and thus also the horizontal lifting axis—can move forward together with the human shoulder, in particular in such a way that the horizontal lifting axis is moved in accordance with the horizontal shoulder joint axis and a correspondence between the horizontal lifting axis and the horizontal pivot axis is expediently maintained.

Preferably, the joint chain is completely passive. The joint chain can also be referred to as shoulder kinematics.

Expediently, the curved movement path is the only degree of freedom of the lifting axis relative to the base section during operation. In particular, the joint chain for the lifting pivot bearing defines only a single movement path—namely the curved movement path. In particular, the support section has only two degrees of freedom relative to the base section during operation—rotation about the lifting axis as the first degree of freedom and movement (together with the lifting pivot bearing) along the curved movement path as the second degree of freedom. Preferably, the second degree of freedom comprises a rotation coupled to the position along the curved movement path about an imaginary vertical axis of rotation lying on the curved movement path. This coupled rotation can expediently not be performed independently of the positioning along the movement path, which is why this rotation and this position together represent only a single degree of freedom—the second degree of freedom—of the support section relative to the base section.

Advantageous further developments are the subject of the subclaims.

The invention further relates to a method according to claim 18.

Further exemplary details and exemplary embodiments are explained below with reference to the figures. Thereby shows

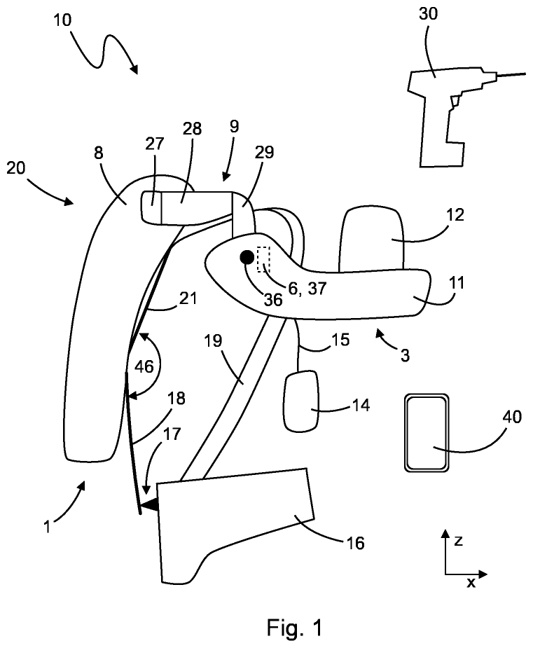

FIG. 1 a schematic side view of an exoskeleton device,

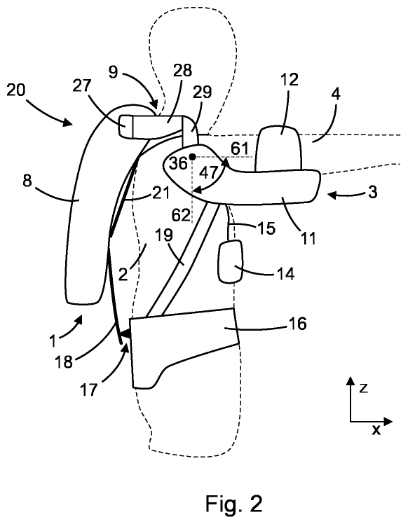

FIG. 2 a schematic side view of an exoskeleton worn by a user,

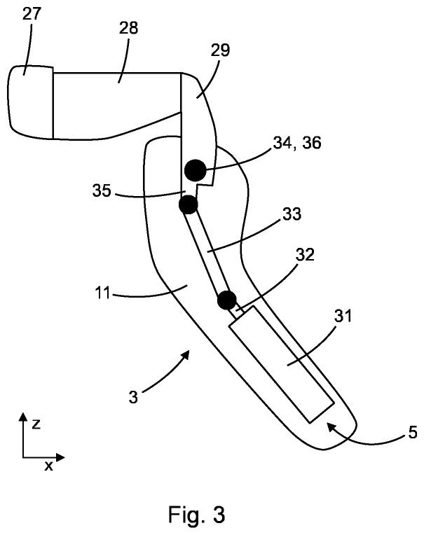

FIG. 3 a schematic detailed view of a support section of the exoskeleton,

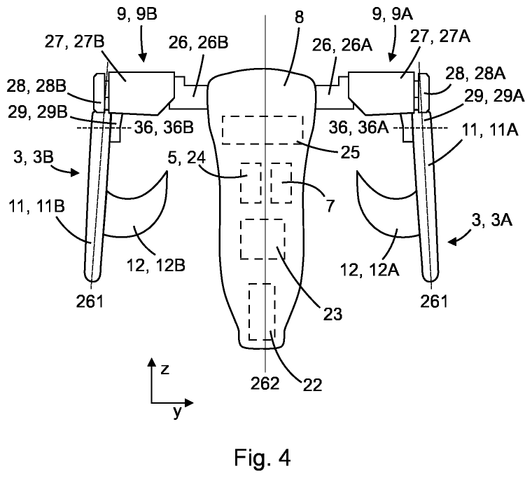

FIG. 4 a schematic rear view of the exoskeleton,

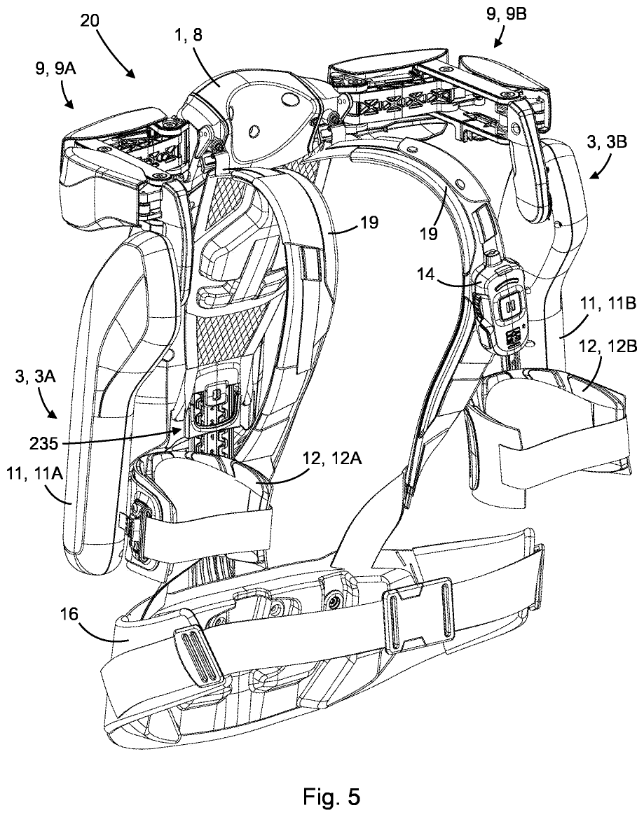

FIG. 5 a perspective view of an exemplary design of an exoskeleton,

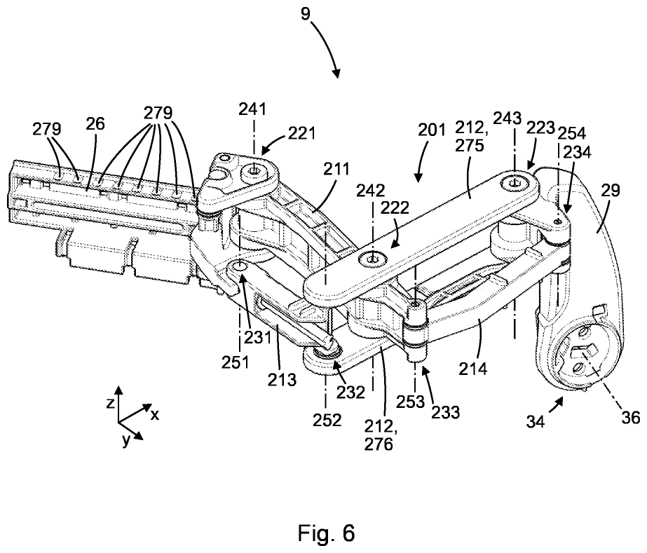

FIG. 6 a perspective view of a shoulder joint arrangement,

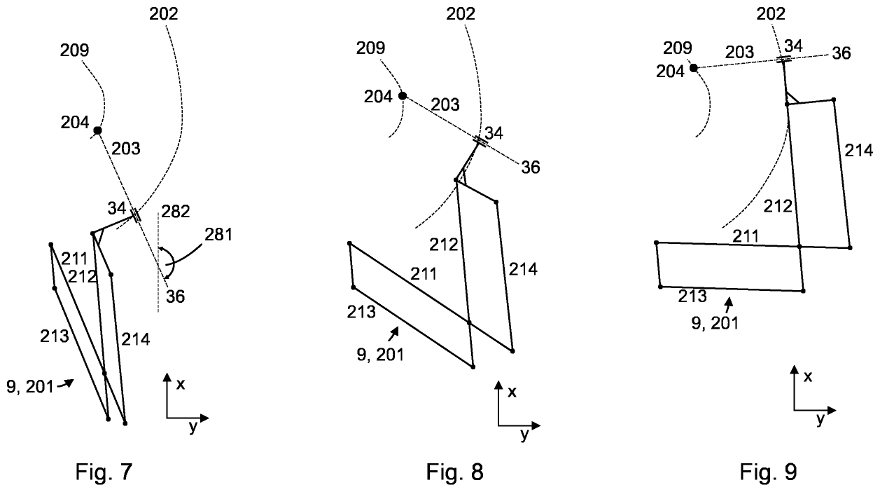

FIG. 7 a schematic top view of a shoulder joint arrangement in a first position,

FIG. 8 a schematic top view of the shoulder joint arrangement in a second position,

FIG. 9 a schematic top view of the shoulder joint arrangement in a third position,

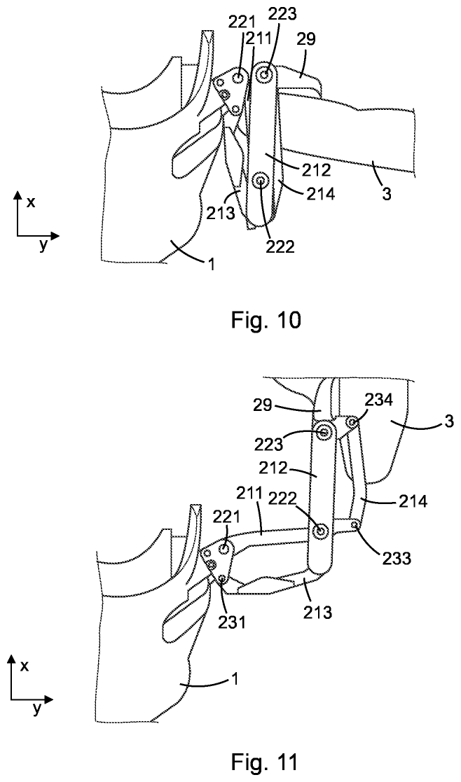

FIG. 10 another schematic top view of a shoulder joint arrangement in the first position,

FIG. 11 another schematic top view of the shoulder joint arrangement in the third position,

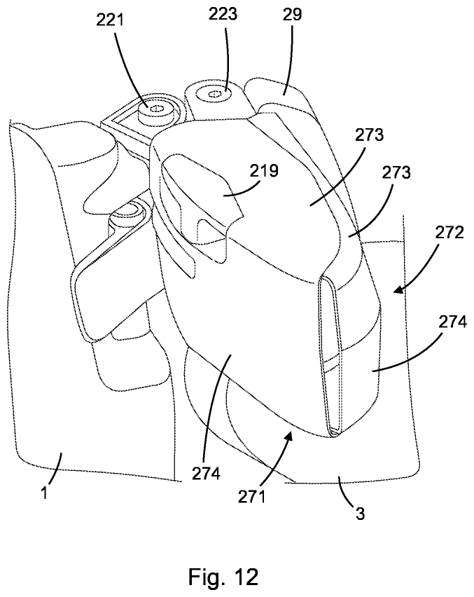

FIG. 12 a perspective view of the shoulder joint arrangement in the first position,

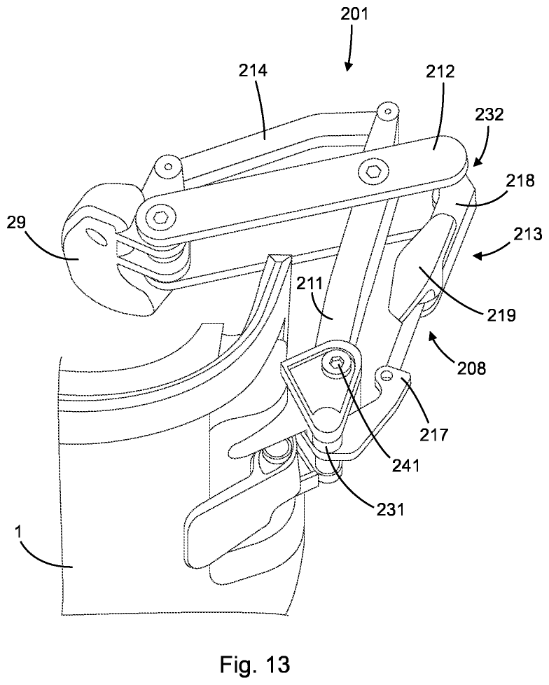

FIG. 13 a perspective view of the shoulder joint arrangement in a folded position,

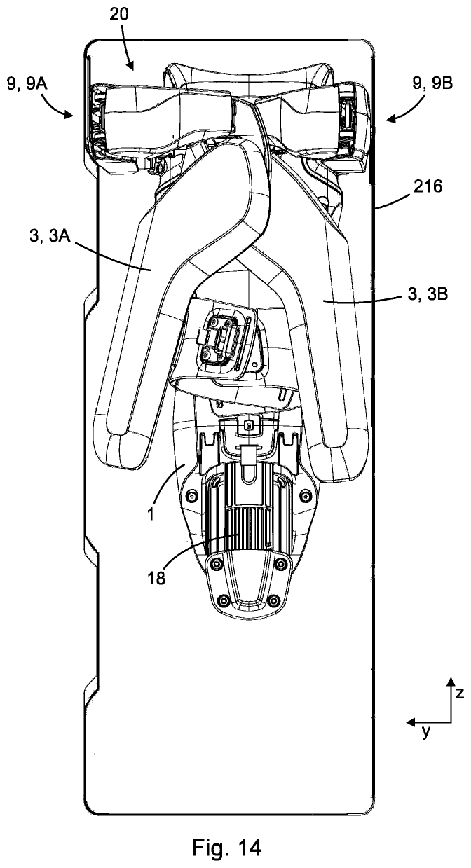

FIG. 14 an exoskeleton in a stowage configuration in a container,

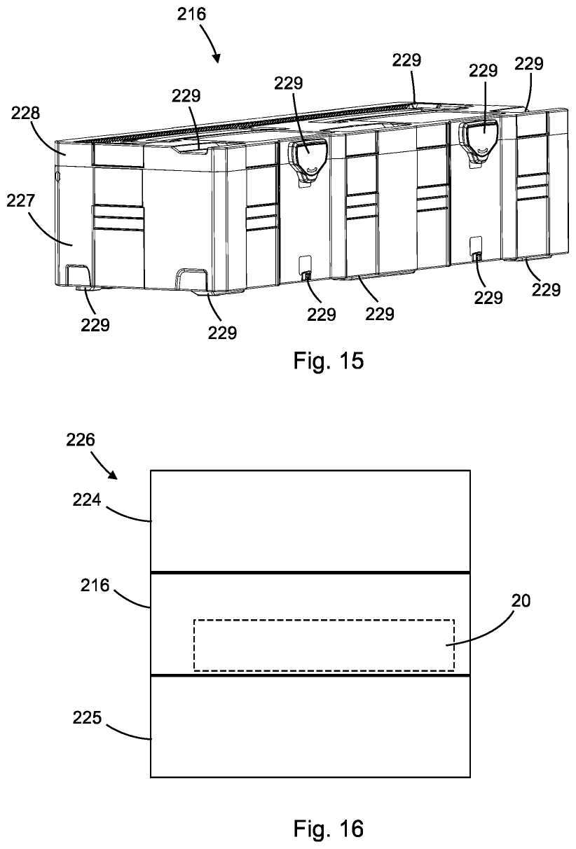

FIG. 15 a perspective view of a container designed as a system box,

FIG. 16 a stack of several containers,

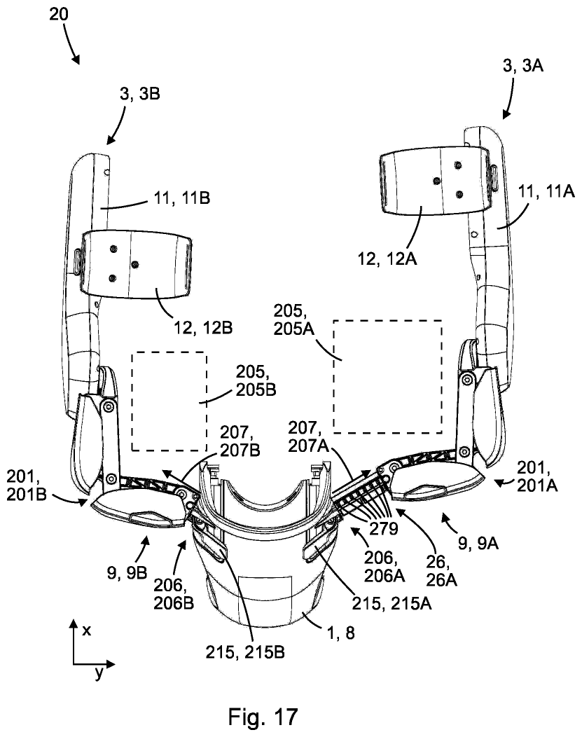

FIG. 17 a top view of the exoskeleton, and

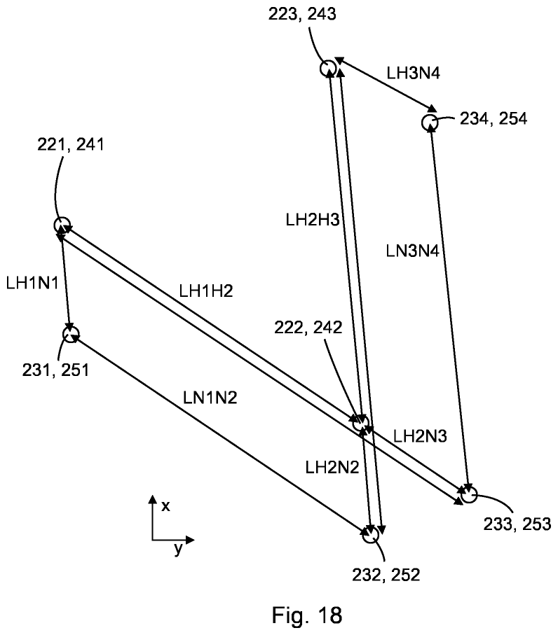

FIG. 18 a schematic representation of distances between axes of rotation of a joint chain.

In the following explanations, reference is made to the spatial directions x-direction, y-direction and z-direction, which are drawn in the figures and are aligned orthogonally to each other. The z-direction can also be referred to as the vertical direction, the x-direction as the depth direction and the y-direction as the width direction.

FIG. 1 shows a schematic representation of an exoskeleton device 10 comprising an exoskeleton 20 and optionally a tool 30 and/or a mobile device 40. The exoskeleton 20 can also be provided on its own. The tool 30 and/or the mobile device 40 are exemplarily provided separately from the exoskeleton 20, i.e. in particular not mechanically connected to the exoskeleton 20. The tool 30 is, for example, a power tool, in particular a cordless screwdriver and/or a drill and/or a grinder. The mobile device 40 is preferably a smartphone or a tablet. Optionally, the exoskeleton 20 is configured to communicate with the tool 30 and/or the mobile device 40, in particular wirelessly.

As an example, the exoskeleton 20 is aligned in an upright orientation with its vertical axis (which in particular runs parallel to a base section axis 62) parallel to the z-direction. In particular, the exoskeleton 20 is aligned in the upright orientation with its sagittal axis parallel to the x-direction. In a state in which the user has put on the exoskeleton 20, the sagittal axis of the exoskeleton 20 runs parallel to the sagittal axis of the user, i.e. in particular parallel to a direction from the rear—i.e. in particular the back of the user—to the front—i.e. in particular the chest of the user. The horizontal axis of the exoskeleton 20 runs in particular in the width direction of the exoskeleton 20 and/or parallel to the y-direction. In a state in which the user has put on the exoskeleton 20, the horizontal axis of the exoskeleton 20 runs parallel to the horizontal axis of the user, i.e. in particular parallel to a direction from a first shoulder of the user to a second shoulder of the user. The vertical axis of the exoskeleton 20, the sagittal axis of the exoskeleton 20 and the horizontal axis of the exoskeleton 20 are aligned orthogonally to each other.

The exoskeleton device 10 is designed in particular for manual and/or industrial use. Preferably, the exoskeleton device 10 is not designed for medical and/or therapeutic use.

The exoskeleton 20 is an active exoskeleton and in particular has an internal energy source from which the energy for the support force is provided. In particular, the exoskeleton 20 is an active exoskeleton for actively supporting the user's shoulder joint.

The exoskeleton 20 comprises a base section 1 for attachment to a body section of a human body of a user. By way of example, the base section 1 serves to be attached to the torso 2 of the human body.

The base section 1 comprises a main section and a textile carrying system, which is in particular detachably attached to the main section. By way of example, the main section serves to be worn on the back of the human body by means of the textile carrying system, in particular in a backpack-like manner. The main section comprises a back part 8, which is in particular elongated and which is expediently aligned with its longitudinal axis vertically and/or in the longitudinal direction of the user's back. For example, the longitudinal direction of the back part 8 extends along the longitudinal direction of the back. The main section further comprises a force transmission element 18, which is in particular strip-shaped and/or rigid and extends downwards from the back part 8 to a pelvic strap 16 in order to mechanically couple the back part 8 to the pelvic strap 16. The force transmission element 18 is expediently used to transmit a reaction force, which is transmitted from a support section 3 to the back part 8, further to the pelvic strap 16. As an example, the back part 8 is tubular and/or backpack-shaped. The back part 8 is in particular rigid. In particular, the back part 8 comprises an expediently rigid back part housing, which is made, for example, from an in particular rigid plastic and/or as a hard shell. The back part 8 expediently serves to transmit a force from the support section 3 to the force transmission element 18 and/or to accommodate components for controlling the support force.

The support section 3 can expediently be referred to as an arm actuator.

The force transmission element 18 is exemplarily sword-shaped and can also be referred to as a sword. Expediently, the force transmission element 18 is designed to be adjustable relative to the back part 8, in particular in order to change the vertical extent of the main section and/or a force transmission element angle 46 between the force transmission element 18 and the back part 8 facing the user's back. Expediently, the force transmission element 18 is mounted for translational and/or rotational movement relative to the back part 8 and, in particular, can be moved into various translational and/or rotational positions relative to the back part 8 and, in particular, can be locked. The translational movement is in particular vertical. The rotational movement is expediently performed about an adjustment axis aligned parallel to the y-direction.

The textile carrying system comprises, by way of example, the pelvic strap 16 and/or at least one, preferably two, shoulder straps 19. The pelvic strap 16 expediently forms a loop so that, when worn, it surrounds the torso 2, in particular the hips, of the user. Each shoulder strap 19 extends exemplarily from the main section, in particular from the back part 8, to the pelvic strap 16, expediently over a respective shoulder of the user when the exoskeleton 20 is worn.

The exoskeleton 20 further comprises, by way of example, a force transmission element joint 17, via which the force transmission element 18 is attached to the pelvic strap 16. The force transmission element joint 17 is designed, for example, as a ball joint and can be referred to as a sacral joint. When the exoskeleton 20 is worn, the force transmission element joint 17 is arranged in the lower back region of the user, in particular centered in the width direction.

By way of example, the textile carrying system also comprises a back net 21, which is arranged on the side of the back part 8 facing the user's back. When the exoskeleton 20 is worn, the back net 21 lies against the user's back, in particular at least partially and/or in the upper back region.

The exoskeleton 20 further comprises the support section 3 movably coupled to the base section 1 for supporting a limb, in particular an arm 4, of the human body of the user. In particular, the support section 3 is designed to be attached to the limb, in particular the arm 4, of the user. The support section 3 comprises, by way of example, an in particular rigid arm part 11 and an arm attachment 12 arranged on the arm part 11, which is designed, by way of example, as an arm shell. The arm part 11 is exemplarily elongated and, when worn, is aligned with its longitudinal axis in the direction of the longitudinal axis of the user's arm. As an example, the arm part 11 extends from the shoulder of the user to the elbow area of the user. The exoskeleton 20, in particular the arm part 11, ends at the elbow area of the user. The arm attachment 12 is used in particular to attach the support section 3 to the arm 4, in particular the upper arm, of the user. In particular, the arm shell surrounds the upper arm of the user, in particular at least partially, so that the upper arm can be held in the arm shell with a strap. The user's forearm is expediently not attached to the exoskeleton 20.

As an example, the support section 3 is mounted so that it can pivot about a horizontal pivot axis relative to the base section 1, in particular relative to the back part 8. As an example, the support section 3 is mounted directly on a shoulder part 29. The horizontal pivot axis can also be referred to as the lifting axis 36. When the exoskeleton 20 is worn, the lifting axis 36 is located in the area of the user's shoulder. In particular, the exoskeleton 20 is designed to support the user's shoulder joint with the support section 3. When the exoskeleton 20 is worn, the user can perform a lifting movement with his arm 4 supported by the support section 3 by pivoting the support section 3 about the lifting axis 36. In particular, the lifting axis 36 can be aligned in the y-direction. Expediently, the lifting axis 36 always lies in a horizontal plane, for example an x-y plane. In particular, a horizontal plane is to be understood as an exactly horizontal plane and/or a plane that is tilted by a maximum of 10 degrees, 7 degrees or 5 degrees relative to a horizon.

The pivot angle 47 of the support section 3 about the lifting axis 36 relative to the base section 1 should also be referred to as the lifting angle. The pivot angle 47 has a reference value, in particular a minimum value, when the support section 3 is oriented downwards (in the case of a vertically oriented exoskeleton 20) and increases continuously up to a maximum value when the support section 3 is pivoted upwards. The minimum value is in particular a minimum value in terms of amount, for example zero.

As an example, the pivot angle 47 is defined as an angle between a support section axis 61 and a base section axis 62. The support section axis 61 extends in the longitudinal direction of the support section 3. Exemplarily, the support section axis 61 extends from the lifting axis 36 in the direction of the arm attachment 12. In a state in which the user has put on the exoskeleton 20, the support section axis 61 expediently extends parallel to an upper arm axis of the arm 4 supported by the support section 3. The base section axis 62 expediently represents a vertical axis of the base section 1 and extends vertically downwards, in particular in a vertical orientation of the base section 1, for example in a state in which the user has put on the exoskeleton 20 and is standing upright. As an example, the pivot angle 47 lies in a z-x plane, for example when the user is standing upright and the arms are raised forwards.

The exoskeleton 20 comprises, by way of example, a shoulder joint arrangement 9, via which the support section 3 is attached to the base section 1, in particular the back part 8. The shoulder joint arrangement 9 expediently comprises a joint chain 201 with one or more pivot bearings for defining one or more vertical axes of rotation. By means of the joint chain 201, it is expediently possible to pivot the support section 3 relative to the base section 1, in particular relative to the back part 8, in a preferably horizontal pivot plane, for example about a virtual vertical axis of rotation. In particular, the joint chain 201 enables the user to pivot his arm 4, which is supported by the support section 3, about a vertical axis of rotation running through the user's shoulder, whereby the support section 3 is moved along with the arm 4. As an example, the joint chain 201 is designed to be passive, so that the exoskeleton 20 does not provide any active support force in the direction of the horizontal pivot movement when the arm is pivoted in the preferably horizontal pivot plane.

The shoulder joint arrangement 9 is expediently arranged and/or designed in such a way that it defines a free space which, when the exoskeleton 20 is worn, is located above the shoulder of the user wearing the exoskeleton 20, so that the user can align his arm, which is supported by the support section 3, vertically upwards through the free space past the shoulder joint arrangement 9.

By way of example, the shoulder joint arrangement 9 comprises an inner shoulder joint section 27, which is mounted so as to be pivotable about a first vertical axis of rotation relative to the base section 1, in particular to the back part 8, by means of a first pivot bearing of the shoulder joint arrangement 9. By way of example, the shoulder joint arrangement 9 further comprises an outer shoulder joint section 28, which is mounted so as to be pivotable about a second vertical axis of rotation relative to the inner shoulder joint section 27 by means of a second pivot bearing of the shoulder joint arrangement 9. By way of example, the shoulder joint arrangement 9 further comprises a shoulder part 29 which is mounted so as to be pivotable about a third vertical axis of rotation relative to the outer shoulder joint section 28 by means of a third pivot bearing of the shoulder joint arrangement 9. Preferably, the inner shoulder joint section 27, the outer shoulder joint section 28 and the shoulder part 29 in the shoulder joint arrangement 9 are kinematically coupled to one another as the joint chain 201 in such a way that the pivot angle of the inner shoulder joint section 27 relative to the base section 1 determines the pivot angle of the outer shoulder joint section 28 relative to the inner shoulder joint section 27 and/or the pivot angle of the shoulder part 29 relative to the outer shoulder joint section 28.

FIG. 3 shows a schematic detailed view of the support section 3, with components arranged within the arm part visibly shown. The arm part 11 expediently comprises an arm part housing, which is in particular rigid and made of plastic, for example.

The exoskeleton 20 comprises an actuator device 5 acting on the support section 3 to provide a support force for the limb, exemplarily for the user's arm. By way of example, the actuator device 5 is arranged at least partially in the arm part 11.

The actuator device 5 is an active actuator device. Expediently, the exoskeleton 20 provides the support force by means of the actuator device 5 with a force component acting upwards in the direction of the pivoting movement about the lifting axis 36, which pushes the user's arm 4 upwards in the direction of the pivoting movement.

Preferably, the actuator device 5 comprises an actuator unit with an actuator member 32. The actuator unit can apply an actuator force to the actuator member 32 in order to provide the support force. The actuator member 32 is coupled to an eccentric section 35 arranged eccentrically to the lifting axis 36. The eccentric section 35 is part of the shoulder part 29, for example. By coupling the actuator member 32 to the eccentric section 35, the actuator force provides a torque of the support section 3 about the lifting axis 36 relative to the base section 1 and/or the shoulder part 29. Due to this torque, the support section 3 presses against the limb, in particular the arm 4, of the user, in particular upwards, and thus provides the support force acting on limb, in particular the arm 4, of the user.

As an example, the actuator device 5 has a coupling element 33, in particular designed as a push rod, via which the actuator member 32 is coupled to the eccentric section 35.

Preferably, the actuator device 5 is a pneumatic actuator device and the actuator unit is expediently designed as a pneumatic drive cylinder 31. The actuator member 32 is the piston rod of the drive cylinder 31.

Alternatively, the actuator device may not be designed as a pneumatic actuator device. For example, the actuator device can be designed as a hydraulic and/or electric actuator device and, expediently, comprise a hydraulic drive unit and/or an electric drive unit as the actuator unit.

The drive cylinder 31, the actuator member 32 and/or the coupling element 33 are preferably arranged in the arm part housing.

The exoskeleton 20 expediently comprises a lifting pivot bearing 34, which provides the lifting axis 36. As an example, the support section 3 is attached to the shoulder joint arrangement 9 via the lifting pivot bearing 34.

FIG. 4 shows a rear view of the exoskeleton 20, whereby the textile support system and the force transmission element 18 are not shown.

The exoskeleton 20 comprises, by way of example, one or more batteries 22, a compressor 23, a valve unit 24 and/or a compressed air tank 25, which are expediently part of the base section 1 and are arranged in particular in the back part housing.

By way of example, the rechargeable battery 22 is arranged at the bottom of the back part 8 and, in particular, is inserted into a rechargeable battery holder of the back part 8 from below. Expediently, the compressed air tank 25 is arranged in an upper region in the back part 8, exemplarily (in particular in the longitudinal direction of the back part 8 and/or vertical direction) above the valve unit 24, the control device 7, the compressor 23 and/or the rechargeable battery 22. The valve unit 24 and/or the control device 7 is (in particular in the longitudinal direction of the back part 8 and/or vertical direction) expediently arranged above the compressor and/or above the rechargeable battery 22. The compressor 23 is arranged (in particular in the longitudinal direction of the back part 8 and/or vertical direction) above the battery 22.

The battery 22 serves as an electrical power supply for the exoskeleton 20, in particular for the compressor 23, the valve unit 24, a sensor device 6 and/or a control device 7.

The compressor 23 is designed to compress air in order to generate compressed air. The compressed air tank 25 is designed to store compressed air—in particular the compressed air generated by the compressor 23.

The valve unit 24 expediently comprises one or more electrically operable valves and is designed in particular to influence a pneumatic connection from the compressed air tank 25 to a pressure chamber of the pneumatic drive cylinder 31, in particular to selectively establish and/or block the pneumatic connection. Expediently, the valve unit 24 is further designed to influence a pneumatic connection from the compressed air tank 25 to the environment of the exoskeleton 20 and/or a pneumatic connection from the pressure chamber of the drive cylinder 31 to the environment of the exoskeleton 20, in particular to selectively establish and/or block the pneumatic connection. The valve unit 24 is expediently part of the actuator device 5.

The exoskeleton 20 further comprises a sensor device 6. As an example, the sensor device 6 comprises an angle sensor 37 for detecting the angle of the support section 3 relative to the base section 1, in particular the arm part 11 relative to the shoulder part 29. This angle should also be referred to as the pivot angle 47 or the lifting angle. The angle sensor 37 is used in particular to detect the angle of the support section 3 about the lifting axis 36. The angle sensor 37 is designed, for example, as an incremental encoder and is arranged in particular on the lifting pivot bearing 34, in particular in the arm part 11 and/or in the shoulder part 29.

Preferably, the sensor device 6 further comprises at least one pressure sensor for detecting the pressure prevailing in the pressure chamber of the drive cylinder 31 and/or the pressure prevailing in the compressed air tank 25. The at least one pressure sensor is expediently arranged in the back part 8 and/or in the arm part 11.

The exoskeleton device 10, in particular the exoskeleton 20, expediently comprises a control device 7, which for example comprises a microcontroller or is designed as a microcontroller. The control device 7 is used in particular to control the actuator device 5, in particular the valve unit 24, in order to control the provision of the support force. Furthermore, the control device 7 is used to read out the sensor device 6, in particular to read out data recorded by the sensor device 6 and/or to communicate with the tool 30 and/or the mobile device 40. Preferably, the control device 7 is designed to adjust the pressure prevailing in the pressure chamber of the drive cylinder 31 by actuating the valve unit 24, in particular to closed-loop control the pressure, for example taking into account a pressure value recorded by means of the pressure sensor. In particular, the control device 7 is designed to increase the pressure prevailing in the pressure chamber by actuating the valve unit 24 in order to increase the support force and/or to reduce the pressure prevailing in the pressure chamber by actuating the valve unit 24 in order to reduce the support force.

According to a preferred embodiment, the control device 7 is designed to adjust the support force on the basis of the pivot angle 47 of the support section 3 detected in particular by means of the angle sensor 37. Expediently, the user can use his muscle strength to change the pivot angle 47 of the support section 3 by pivoting his arm 4, thereby influencing in particular the provision of the support force. In particular, the support force is low enough so that the user can change the pivot angle 47 of the support section 3 by pivoting his arm 4 using his muscle strength. The support force is limited, for example, by the design of the pneumatic system, in particular the compressor, and/or by the control device 7.

The control device 7 is preferably part of the exoskeleton 20 and is exemplarily arranged in the base section 1, in particular in the back part 8. Optionally, the control device 7 can be at least partially implemented in the mobile device 40.

As an example, the exoskeleton 20 comprises an operating element 14, which is expediently attached to the base section 1 via an operating element cable 15. The user can control the exoskeleton 20 via the operating element 14 and, in particular, activate, deactivate and/or set the support force to one of several possible force values greater than zero.

As an example, the exoskeleton 20 further has a connecting element 26, via which the shoulder joint arrangement 9 is attached to the base section 1, in particular the back part 8. The connecting element 26 is exemplarily designed as a pull-out element. The connecting element 26 is expediently adjustable in its position relative to the base section 1, in particular relative to the back part 8, in order to be able to adapt the position of the shoulder joint arrangement 9 and the support section 3 to the shoulder width of the user. In particular, the position of the connecting element 26 can be adjusted by pushing or pulling the connecting element 26 in or out of the back part 8.

By way of example, the exoskeleton 20 has a first support section 3A, a first shoulder joint arrangement 9A and a first connecting element 26A, as well as a second support section 3B, a second shoulder joint arrangement 9B and a second connecting element 26B. The components whose reference signs are provided with the suffix “A” or “B” are expediently each designed in correspondence with the components provided with the same reference sign number but without the suffix “A” or “B”, for example identical or mirror-symmetrical, so that the explanations in this regard apply in correspondence. The “A” and “B” components of the exoskeleton are shown in particular in FIGS. 4, 5 and 17.

The first support section 3A, the first shoulder joint arrangement 9A and the first connecting element 26A are arranged on a first, exemplarily the right, side (in width direction) of the base section 1, and serve to support a first, in particular the right, arm of the user.

The second support section 3B, the second shoulder joint arrangement 9B and the second connecting element 26B are arranged on a second, exemplarily the left, side (in width direction) of the base section 1 and serve to support a second, in particular the left, arm of the user.

The first support section 3A comprises a first arm part 11A, a first arm attachment 12A and/or a first actuator unit, in particular a first drive cylinder.

The second support section 3A comprises a second arm part 11B, a second arm attachment 12B and/or a second actuator unit, in particular a second drive cylinder.

Preferably, the control device 7 is designed to set a first support force for the first support section 3A by means of the first actuator unit and to set a second support force for the second support section 3B by means of the second actuator unit, which second support force is expediently different from the first support force.

The first shoulder joint arrangement 9A comprises a first inner shoulder joint section 27A, a first outer shoulder joint section 28A and a first shoulder part 29A. The second shoulder joint arrangement 9B comprises a second inner shoulder joint section 27B, a second outer shoulder joint section 28B and a second shoulder part 29B.

The first support section 3A is pivotable about a first horizontal lifting axis 36A relative to the base section 1 and the second support section 3B is pivotable about a second horizontal lifting axis 36B relative to the base section 1.

In FIG. 2, the exoskeleton 20 is shown in a state in which it is worn by a user, in particular worn as intended. By the formulation that the user is wearing the exoskeleton 20, in particular wearing it as intended, it is meant that the user has put on the exoskeleton, i.e. put it on, by way of example in that the user is wearing the back part 8 on his back like a backpack, has put on the pelvic strap 16 around his hips, the shoulder strap or shoulder straps 19 run over the shoulder or shoulders of the user and/or one or both arms of the user are attached to the respective support section 3 with a respective arm attachment 12.

By way of example, the exoskeleton 20 is designed to support the user during a lifting movement of a respective arm, i.e. during an upwardly directed pivoting of the respective support section 3 about a respective lifting axis 36, with a respective support force acting in particular upwards. Furthermore, the exoskeleton 20 is expediently designed to support or counteract the user during a lowering movement, i.e. during a downward pivoting of the respective support section 3 about a respective lifting axis 36, with a respective support force acting in particular upwards, or to deactivate or reduce the respective support force during the lowering movement.

The shoulder joint arrangement 9 will be discussed in more detail below. An exemplary design of the shoulder joint arrangement 9 is shown in FIG. 6. The support section 3 is movably coupled to the base section 1 via the shoulder joint arrangement 9.

The shoulder joint arrangement 9 comprises the lifting pivot bearing 34, via which the support section 3 is pivotably mounted on the shoulder joint arrangement 9 about the horizontal lifting axis 36. As an example, the arm part 11 is mounted on the shoulder part 29 so that it can pivot about the horizontal lifting axis 36 via the lifting pivot bearing 34.

The shoulder joint arrangement 9 comprises the joint chain 201, which defines a curved movement path 202 relative to the base section 1 for the lifting pivot bearing 34. The curved movement path 202 preferably lies in a plane, in particular in a horizontal plane. An exemplary movement path 202 is shown in FIGS. 7, 8 and 9. In particular, during operation of the exoskeleton 20, the joint chain 201 limits a positioning of the lifting pivot bearing 34 relative to the base section 1 to the curved movement path 202.

Preferably, by means of the joint chain 201, the positioning of the lifting pivot bearing 34 along the curved movement path is fixedly coupled to a rotation of the lifting pivot bearing 34 about an imaginary vertical axis of rotation running through the lifting pivot bearing 34. When the lifting pivot bearing 34 is moved along the movement path, the lifting pivot bearing 34 therefore necessarily rotates about its own vertical axis—the imaginary vertical axis of rotation running with the lifting pivot bearing 34, which expediently results in a horizontal pivoting movement of the support section 3 relative to the base section 1. The rotation of the lifting pivot bearing about the imaginary vertical axis of rotation should also be referred to as the self-rotation of the lifting pivot bearing 34.

Preferably, the joint chain 201 is designed to pivot the lifting pivot bearing 34 about an imaginary vertical axis of rotation extending through the lifting pivot bearing 34 as a function of the path position of the lifting pivot bearing 34 on the movement path 202, so that, by performing a movement of the lifting pivot bearing 34 along the movement path 202, the support section 3 can be pivoted horizontally relative to the base section 1.

In particular, the joint chain 201 is designed in such a way that the horizontal pivoting of the support section 3 relative to the base section 1 does not take place about an imaginary vertical axis of rotation that is fixed (relative to the base section 1), but instead about an imaginary vertical axis of rotation that moves in a horizontal plane (depending on the horizontal pivoting).

The horizontal pivoting of the support section 3 relative to the base section 1 can be described by means of a horizontal pivot angle between the support section 3 and a horizontal axis of the base section 1, for example an axis running parallel to the x-direction, which can also be referred to as the depth axis or sagittal axis.

Preferably, the joint chain 201 is designed to guide the lifting pivot bearing 34 on the movement path 202 in such a way that the lifting axis 36 is aligned along the movement path 202, in particular along the entire movement path 202, correspondingly, in particular coaxially, to a horizontal shoulder joint axis 203 of a shoulder, in particular of a shoulder joint 204, of a user wearing the exoskeleton 20, in particular during a lifting movement of the arm 4 and/or during a horizontal pivoting movement of the arm 4.

Expediently, the shoulder joint arrangement 9 does not couple the vertical pivoting of the support section 3—i.e. the pivot angle 47—with the path position of the lifting pivot bearing 34 along the curved movement path 202 and/or with the horizontal pivot angle of the support section 3. When vertically pivoting forward (in particular at a pivot angle 47 of 0 to 90 degrees), the human shoulder is moved in the x-direction forward about a pivot axis aligned parallel to the y-direction, which in the worn state of the exoskeleton 20 results in the support section 3 and thus the lifting pivot bearing 34 being moved forward along the curved movement path 202 by the arm 4. The movement along the curved movement path 202 in turn causes the self-rotation of the lifting pivot bearing 34—and thus of the lifting axis 36—so that the spatial orientation of the lifting axis 36 follows the spatial orientation of the horizontal shoulder joint axis 203.

This enables optimum force transmission and prevents unnatural postures or forced postures on the part of the user.

With reference to FIGS. 7, 8 and 9, the curved movement path 202 defined by the joint chain 201 will be discussed in more detail below.

Preferably, the movement path 202 has a curvature that changes along the movement path 202, so that the movement path 202 is not circular. The movement path 202 has a concave shape facing the center of the exoskeleton 20 in the width direction.

FIGS. 7, 8, 9 also show an exemplary curved shoulder axis movement path 209, on which the shoulder joint 204 and/or the horizontal shoulder joint axis 203 moves during a (vertical) lifting movement and/or during a horizontal pivoting movement of the arm 4.

As an example, the movement path 202 has a smaller curvature than the shoulder axis movement path 209 and/or runs around the outside of the shoulder axis movement path 209. In particular, the course of the movement path 202 corresponds to the course of the shoulder axis movement path 209 and/or, in particular, is concave in relation to the center of the exoskeleton (in the width direction).

Optionally, the shoulder part 29 and/or the lifting pivot bearing 34 has a constant distance to the user's shoulder in every position of the joint chain 201.

Optionally (in particular due to the course of the movement path 202), the arm attachment 12 abuts against the same place on the arm 4 in every position of the arm part 11 when the arm 4 is raised or lowered and/or pivoted horizontally. In this way, a relative movement between the arm 4 and the arm attachment 12 can be reduced and/or the wearing comfort for the user can be increased.

With reference to FIG. 6, an exemplary structure of the joint chain 201 is described below.

Preferably, the joint chain 201 comprises a first main joint element 211, a first auxiliary joint element 213, a second main joint element 212, a second auxiliary joint element 214 and the shoulder part 29 comprising the lifting pivot bearing 34.

The joint elements 211, 212, 213, 214 are expediently each elongated, in particular rod-shaped and/or bar-shaped. Expediently, the joint elements 211, 212, 213, 214 are each aligned with their longitudinal axis in a horizontal plane.

The joint chain 201 further comprises a first main pivot bearing 221, via which the first main joint element 211 is rotatably mounted relative to the base section 1, and a first auxiliary pivot bearing 231, via which the first auxiliary joint element 213 is rotatably mounted relative to the base section 1.

The joint chain 201 further comprises a second main pivot bearing 222, via which the second main joint element 212 is rotatably mounted on the first main joint element 211, and a second auxiliary pivot bearing 232, via which the second main joint element 212 is rotatably mounted on the first auxiliary joint element 213.

The joint chain 201 further comprises a third auxiliary pivot bearing 233, via which the second auxiliary joint element 214 is rotatably mounted on the first main joint element 211, and a third main pivot bearing 223, via which the shoulder part 29 is rotatably mounted on the second main joint element 212.

The joint chain 201 further comprises a fourth auxiliary pivot bearing 234, via which the shoulder part 29 is rotatably mounted on the second auxiliary joint element 214.

Expediently, the first main joint element 211 and the second main joint element 212 intersect, in particular at a second main axis of rotation 242 provided by the second main pivot bearing 222.

The second main pivot bearing 222 is arranged in the longitudinal direction of the second main joint element 212 between the second auxiliary pivot bearing 232 and the third main pivot bearing 243. Furthermore, the second main pivot bearing 222 is arranged in the longitudinal direction of the first main joint element 211 between the first main pivot bearing 221 and the third auxiliary pivot bearing 233.

Expediently, the first main joint element 211 and the first auxiliary joint element 213 extend parallel to each other. The second main joint element 212 and the second auxiliary joint element 214 expediently extend parallel to one another in at most one position of the joint chain 201. In particular, the second main joint element 212 and the second auxiliary joint element 214 do not run parallel to one another in several positions of the joint chain 201 and expediently have different angles relative to one another.

Alternatively, it may be provided that the second main joint element 212 and the second auxiliary joint element 214 run parallel to one another.

By way of example, the first main joint element 211 and/or the first auxiliary joint element 213 forms the aforementioned inner shoulder joint section 27. By way of example, the second main joint element 212 and/or the second auxiliary joint element 214 forms the aforementioned outer shoulder joint section 28.

The joint chain 201 is designed in particular as a kinematic system whose joint elements 211, 212, 213, 214 are expediently movable only in one (in particular non-variable) plane, in particular a horizontal plane. The kinematic system is designed in such a way that a virtual vertical pivot axis of the joint chain 201 formed by the kinematic system follows the pivot point of the shoulder when the arm 4 is raised or lowered. Optionally, the joint chain 201 can be designed as a double parallelogram kinematic system.

As shown in FIG. 6, the first main joint element 211 is mounted on the connecting element 26 via the first main pivot bearing 221. Furthermore, the first auxiliary joint element 213 is mounted on the connecting element 26 via the first auxiliary pivot bearing 231. The connecting element 26 connects the joint chain 201 to the back part 8.

The first main joint element 211 is connected to the connecting element 26 and is rotatable in a horizontal plane. The second main joint element 212 crosses over the first main joint element 211, the joint elements 211, 212 being rotatably connected to one another in the horizontal plane. The auxiliary joint element 213, designed in particular as a coupling rod, connects one end of the second main joint element 212 to the connecting element 26, the connections being rotatably mounted. Furthermore, the second auxiliary joint element 214, designed in particular as a coupling rod, connects one end of the first main joint element 211 to the shoulder part 29. The joint chain 201 is connected to the support section 3 via the shoulder part 29.

As an example, the shoulder part 29 is elongated and aligned vertically with its longitudinal axis. The support section 3 is expediently mounted at one end, in particular at a lower and/or free end of the shoulder part 29 so as to be rotatable about a horizontal axis—the lifting axis 36.

The joint chain 201, which comprises the joint elements 211, 212, 213, 14, expediently forms a double parallelogram. The shape of the curved movement path 202 is expediently defined via the length ratios of the joint elements 211, 212, 213, 214.

Preferably, the movement along the movement path 202 provided by the joint chain 201 is the only degree of freedom for positioning the lifting pivot bearing 34 relative to the base section during operation. The self-rotation of the lifting pivot bearing 34—i.e. the rotation of the lifting axis 36 about an imaginary vertical axis of rotation—is expediently coupled to the movement along the movement path and therefore does not represent a separate degree of freedom.

Expediently, all pivot bearings 221, 222, 223, 231, 232, 233, 234 of the joint chain 201 are coupled to one another via the joint chain 201, so that none of these pivot bearings can provide rotation independently of the other pivot bearings of the joint chain 201. The currently provided rotation angle of each of the pivot bearings of the joint chain 201 depends on the position of the lifting pivot bearing 34 on the curved movement path 202. In particular, none of the pivot bearings 221, 222, 223, 231, 232, 233, 234 provides an independent degree of freedom.

With reference to FIG. 18, exemplary length ratios of the distances defined by the joint elements 211, 212, 213, 214 between the axes of rotation of the joint chain 201 will be discussed in more detail below.

Preferably, the ratio of a distance LH2H3 between the axis of rotation 242 of the second main pivot bearing 222 and the axis of rotation 243 of the third main pivot bearing 223 to the distance LH1H2 between the axis of rotation 242 of the second main pivot bearing 222 and the axis of rotation 241 of the first main pivot bearing 221 is between 0.75 and 1. Expediently, LH2H3/LH1H2 is between 0.75 and 1.

The axis of rotation 241 can be referred to as the first main axis of rotation 241, the axis of rotation 242 as the second main axis of rotation 242 and the axis of rotation 243 as the third main axis of rotation 243. The axes of rotation 241, 242, 243 are in particular vertical axes of rotation.

Preferably, the ratio of the distance LH2N2 between the axis of rotation 242 of the second main pivot bearing 222 and the axis of rotation 252 of the second auxiliary pivot bearing 232 to the distance LH1N1 between the axis of rotation 241 of the first main pivot bearing 221 and the axis of rotation 251 of the first auxiliary pivot bearing 231 is equal to 1. Expediently, LH2N2/LH1N1 is equal to 1.

The axis of rotation 251 can also be referred to as the first auxiliary axis of rotation 251, the axis of rotation 252 as the second auxiliary axis of rotation 252, the axis of rotation 253 as the third auxiliary axis of rotation 253 and the axis of rotation 254 as the fourth auxiliary axis of rotation 254. The axes of rotation 251, 252, 253, 254 are in particular vertical axes of rotation.

Preferably, the ratio of the distance LH2N2 between the axis of rotation 242 of the second main pivot bearing 222 and the axis of rotation 252 of the second auxiliary pivot bearing 232 to the distance LH3N4 between the axis of rotation 243 of the third main pivot bearing 223 and the axis of rotation 254 of the fourth auxiliary pivot bearing 234 is equal to 1. Expediently, LH2N2/LH3N4 is equal to 1.

Preferably, the ratio of the distance LH2N2 between the axis of rotation 242 of the second main pivot bearing 222 and the axis of rotation 252 of the second auxiliary pivot bearing 232 to the distance LH2N3 between the axis of rotation 242 of the second main pivot bearing 222 and the axis of rotation 253 of the third auxiliary pivot bearing 233 is between 0.85 and 1. Expediently, LH2N2/LH2N3 is between 0.85 and 1.

Preferably, the ratio of the distance LH1H2 between the axis of rotation 241 of the first main pivot bearing 221 and the axis of rotation 242 of the second main pivot bearing 222 to the distance LN1N2 between the axis of rotation 251 of the first auxiliary pivot bearing 231 and the axis of rotation 252 of the second auxiliary pivot bearing 232 is equal to 1. Expediently, LH1H2/LN1N2 is equal to 1.

Preferably, the ratio of the distance LH2H3 between the axis of rotation 242 of the second main pivot bearing 222 and the axis of rotation 243 of the third main pivot bearing 223 to the distance LN3N4 between the axis of rotation 253 of the third auxiliary pivot bearing 233 and the axis of rotation 254 of the fourth auxiliary pivot bearing 234 is between 0.9 and 1. Expediently, LH2H3/LN3N4 is between 0.9 and 1.

The specified value ranges for the ratios include the specified limit values and these specified limit values can therefore also be adopted as the ratios.

Preferably, a first quadrilateral, in particular a first parallelogram, is formed from a first imaginary straight line connecting the first main axis of rotation 241 and the second main axis of rotation 242, a second imaginary straight line connecting the first auxiliary axis of rotation 251 and the second auxiliary axis of rotation 252, a third imaginary straight line connecting the first main axis of rotation 241 and the first auxiliary axis of rotation 251, and a fourth imaginary straight line connecting the second main axis of rotation 242 and the second auxiliary axis of rotation 252. In particular, the first imaginary connecting straight line is of the same length as the second imaginary connecting straight line and/or parallel to the second imaginary connecting straight line. In particular, the third imaginary connecting straight line is of the same length as the fourth imaginary connecting straight line and/or parallel to the fourth imaginary connecting straight line.

Preferably, a second quadrilateral is formed from a fifth imaginary connecting straight line between the second main axis of rotation 242 and the third main axis of rotation 243, a sixth imaginary connecting straight line between the third auxiliary axis of rotation 253 and the fourth auxiliary axis of rotation 254, a seventh imaginary connecting straight line between the second main axis of rotation 242 and the third auxiliary axis of rotation 253 and an eighth imaginary connecting straight line between the third main axis of rotation 243 and the fourth auxiliary axis of rotation 254.

Preferably, the second quadrilateral is an irregular quadrilateral, in particular a quadrilateral other than a parallelogram. In the second quadrilateral, the fifth imaginary connecting straight line is expediently not the same length as, in particular shorter than, the sixth imaginary connecting straight line and/or the eighth imaginary connecting straight line is not the same length as, in particular shorter than, the seventh imaginary connecting straight line. In particular, the distance LH3N4 between the axis of rotation 243 of the third main pivot bearing 223 and the axis of rotation 254 of the fourth auxiliary pivot bearing 234 unequal to or smaller than the distance LH2N3 between the axis of rotation 242 of the second main pivot bearing 222 and the axis of rotation 253 of the third auxiliary pivot bearing 233 and/or the distance LH2H3 between the axis of rotation 242 of the second main pivot bearing 222 and the axis of rotation 243 of the third main pivot bearing 223 is unequal to or smaller than the distance LN3N4 between the axis of rotation 253 of the third auxiliary pivot bearing 233 and the axis of rotation 254 of the fourth auxiliary pivot bearing 234.

Expediently, in one position of the joint chain 201, the second quadrilateral can take the form of a trapezoid with only two parallel sides. For example, in (in particular at most) one position of the joint chain 201, the fifth imaginary straight line and the sixth imaginary straight line are parallel to one another, and the seventh imaginary straight line and the eighth imaginary straight line are not parallel to one another in this position.

Preferably, the axes of rotation of the second main pivot bearing 222, the third main pivot bearing 223, the third auxiliary pivot bearing 233 and the fourth auxiliary pivot bearing 234 lie on corners of an imaginary quadrilateral (namely the second quadrilateral) which is not a parallelogram and is preferably an irregular quadrilateral.

Preferably, the second quadrilateral is not a parallelogram.

Optionally, the second quadrilateral can be designed as a parallelogram.

Optionally, the aforementioned connecting lines between the axes of rotation 241, 242, 243, 251, 252, 253, 254 form a double parallelogram.

The lengths of the connecting lines mentioned correspond to the distances between the axes of rotation mentioned above.

The length ratios in the second parallelogram and the length ratios between the first and second parallelogram define the course of the curved movement path 202.

In particular, the above-mentioned length ratios of the connecting lines—i.e. the distances between the axes of rotation—define the curvature of the curved movement path 202, which changes along the movement path and on the basis of which the lifting axis 36 follows the horizontal shoulder joint axis 203 of the user during a lifting movement of the user's upper arm attached to the support section 3. In this way, the shoulder kinematics of the exoskeleton 20 can adapt to the natural movement of the shoulder and arm. This can lead to a favorable transmission of the support force, whereby incorrect loads on the arm and shoulder can be avoided and a large range of motion and a high level of comfort for the user can be achieved.

Preferably, the exoskeleton 20 defines a free space 205 which, when the exoskeleton 20 is worn, is located above the shoulder of the user wearing the exoskeleton 20 and around which the joint chain 201 extends, so that the user can point his arm 4 supported by the support section 3 upwards, in particular above shoulder height, preferably vertically upwards, through the free space 205 past the joint chain 201.

FIG. 17 shows the free space 205, which exemplarily comprises a first free space 205A (for the right arm) and a second free space 205B (for the left arm).

In particular, the joint chain 201 can assume an L-shaped position—for example a fold-out position—in which the first main joint element 211 extends outwards in the y-direction starting from the back part 8 and/or the connecting element 26, in particular (in the x-direction) behind the shoulder of the user, and delimits the free space 205 in the x-direction. Expediently, in the L-shaped position, the second main joint element 212 extends forward in the x-direction starting from the first main joint element 211, in particular (in the y-direction) laterally outside the area occupied by the shoulder, and delimits the free space 205 in the y-direction.

The joint chain 201 is therefore expediently located completely behind and/or to the side of the user's shoulder, and in particular not above the shoulder, so that the user's freedom of movement is not restricted by the joint chain 201 during overhead activities.

With reference to FIGS. 10 and 11, various positions of the joint chain 201 will be discussed below.

FIG. 10 shows a first end position of the joint chain 201, which can also be referred to as the fold-in position. In the fold-in position, the joint chain 201 is folded in as far as possible. In the fold-in position, the lifting pivot bearing 34 is located at a first end of the curved movement path 202, in particular in a position that can be occupied by the lifting pivot bearing 34 minimally in the x-direction—i.e. in particular in a position maximally to the rear. In the folded-in position, the horizontal angle 281 between the lifting axis 36 and the sagittal axis (running parallel to the x-direction) of the exoskeleton 20 is preferably maximum, in particular greater than 90 degrees or greater than 120 degrees or greater than 150 degrees. In the fold-in position, the joint chain 201 has a V-shape in plan view, for example. The horizontal angle 281 is shown in FIG. 7, for example in relation to an imaginary straight line 282 running parallel to the sagittal axis. The horizontal angle 281 is defined in particular in such a way that it would be zero if the lifting axis 36 were aligned forwards in the x-direction. The horizontal angle 281 increases as the support section 3 is pivoted further outwards.

When the exoskeleton 20 is worn, the joint chain 201 assumes the fold-in position in particular when the user places his arms against the body and/or stretches out to the side or back.

FIG. 11 shows a second end position of the joint chain 201, which can also be referred to as the fold-out position. In the fold-out position, the joint chain 201 is folded out to the maximum. In the fold-out position, the lifting pivot bearing 34 is located at a second end of the curved movement path 202, in particular in a position that can be occupied by the lifting pivot bearing 34 maximally in the x-direction—i.e. in particular in a position maximally forward. In the folded-in position, the horizontal angle between the lifting axis 36 and the sagittal axis (running parallel to the x-direction) of the exoskeleton 20 is preferably minimal, in particular less than or equal to 90 degrees. In the fold-out position, the joint chain 201 has an L-shape in plan view, for example.

When the exoskeleton 20 is worn, the joint chain 201 assumes the fold-out position in particular when the user extends his arms forwards.

With reference to FIG. 12, an overlapping of cover caps 271, 272 in the folded-in position will be discussed below.

By way of example, the shoulder joint arrangement 9 comprises a first cover cap 271 and/or a second cover cap 272. In particular, the first cover cap 271 is associated with and/or attached to the inner shoulder joint section 27, by way of example the first auxiliary joint element 213. In particular, the second cover cap 272 is associated with and/or attached to the outer shoulder joint section 28, for example the second auxiliary joint element 214. The first cover cap 271 surrounds the inner shoulder joint section 27 at least partially, in particular on at least two sides. The second cover cap 272 surrounds the outer shoulder joint section 28 at least partially, in particular on at least two sides.

Each cover cap 271, 272 expediently comprises a respective upper and/or lower horizontal cover cap section 273 for covering the joint chain 201 upwards and/or downwards, and/or a respective vertical cover cap section 274 for covering the joint chain 201 outwards. The cover caps 271, 272 are expediently made of plastic.

Preferably, in the folded-in position, the upper and/or lower horizontal cover cap section 273 of the first cover cap 271 overlaps with the upper and/or lower horizontal cover cap section 273 of the second cover cap 272. Exemplarily, in the folded-in position, one of the cover caps, exemplarily the first cover cap 271, embraces the other cover cap, exemplarily the cover cap 272. In particular, in the folded-in position, an upper cover cap section 273 is inserted in the vertical direction between another upper cover cap section 273 and the joint elements 211, 212 and/or a lower cover cap section is inserted in the vertical direction between another lower cover cap section and the joint elements 211, 212. In the fold-out position, the upper and/or lower horizontal cover cap sections 273 expediently do not overlap or only partially overlap.

Preferably, the first main pivot bearing 221 is located directly next to the third main pivot bearing 223 in the folded-in position and, in particular, rests against it.

As shown as an example in FIG. 6, the first main joint element 211 and/or the second auxiliary joint element 214 is preferably arranged vertically offset to the second main joint element 212. In the folded-in position, an in particular horizontal pivot angle between the first main joint element 211 and the second main joint element 212 is expediently minimal. In the folded-in position, the first main joint element 211 and/or the second auxiliary joint element 214 expediently overlaps horizontally with the second main joint element 212 with more than half of the respective longitudinal extension.

As can be seen in FIG. 6, the second main joint element 212 comprises, by way of example, two joint element sections 275, 276 arranged vertically offset to one another, namely an upper joint element section 275 and a lower joint element section 276. The first main joint element 211 and/or the second auxiliary joint element 214 is arranged in the z-direction between the two joint element sections 275, 276, so that the first main joint element 211 and/or the second auxiliary joint element 214 in the folded-in position can at least partially plunge into the intermediate space between the two joint element sections 275, 276.

Preferably, the joint elements 211, 212, 214 and/or the cover caps 271, 272 are plunged and/or folded into one another in the folded-in position, as can be seen in FIG. 10. In this way, a high range of motion and/or a compact exoskeleton 20 can be achieved for the user.

With reference to FIG. 17, an adjustment mechanism 206 for adapting the exoskeleton 20 to a shoulder width of the user will be explained in more detail below.

Preferably, the exoskeleton 20 comprises an adjustment mechanism 206 by means of which the shoulder joint arrangement 9 can be positioned in an adjustment direction 207 relative to the base section 1, in particular relative to the back part 8, in order to adapt the exoskeleton 20 to the shoulder width of the user.

The adjustment mechanism 206 expediently comprises the connecting element 26, which is in particular elongate, for example strip-shaped, and which can expediently be pushed into the back part 8 and/or pulled out of the back part 8 in the manner of an pull-out in order to position the shoulder joint arrangement 9 (together with the support section 3) in the adjustment direction 207 relative to the back part 8.

In particular, the adjustment mechanism 206 comprises an actuating element 215 designed, for example, as a lever, in particular as a clamping lever, by actuating which the user can fix the shoulder joint arrangement 9 (together with the support section 3) in a set position (in the adjustment direction 207) relative to the base section 1, in particular relative to the back part 8. Expediently, by actuating the actuating element 215, the connecting element 26 can be fixed, in particular clamped, in its set position relative to the back part 8.

Preferably, the adjustment mechanism 206, in particular the connecting element 26 and/or the actuating element 215, is arranged in an upper and/or lateral region of the back part 8.

For example, the adjustment mechanism 206 comprises a locking section which can be moved selectively into a locking position or a release position by actuating the actuating element 215. In particular, in the locking position, the locking section is in positive engagement and/or frictional engagement with the connecting element 26. Expediently, in the release position, the locking section is not in positive engagement and/or not in frictional engagement with the connecting element 26.

Preferably, the adjustment mechanism 206 has discrete width adjustment positions 279, which are designed, for example, as detent points arranged in particular on the connecting element 26. The detent points are, for example, punctual indentations. The width adjustment positions 279 are used for adjustment to the shoulder width of the user. Optionally, the discrete width adjustment positions have at least in part width markings. In particular, the adjustment mechanism provides a stepped adjustment of the exoskeleton to the shoulder width of the user, i.e. expediently not a stepless adjustment.

The adjustment direction 207 is expediently directed forwards by an angle of incidence relative to a horizontal axis of the exoskeleton 20 running parallel to the y-direction. The angle of incidence is preferably greater than 15 degrees or greater than 20 degrees or greater than 27 degrees or less than 45 degrees or less than 37 degrees or less than 32 degrees. As an example, the angle of incidence is 30 degrees.

By adjusting the shoulder joint arrangement 9 along the adjustment direction 207, the lifting pivot bearing 34 is expediently adjusted further outwards in the y-direction and/or further forwards in the x-direction.

By way of example, the shoulder joint arrangement 9 is the first shoulder joint arrangement 9A, the adjustment mechanism 206 is a first adjustment mechanism 206A and the adjustment direction 207 is a first adjustment direction 207A. The exoskeleton 20 further comprises the second shoulder joint arrangement 9B and a second adjustment mechanism 206B, via which the second shoulder joint arrangement 9B can be positioned in a second adjustment direction 207B relative to the base section 1. The first adjustment direction 207A and the second adjustment direction 207B intersect at an obtuse angle (in particular opened forwards in the x-direction), in particular at an angle smaller than 150 degrees or smaller than 135 degrees or smaller than 125 degrees and/or at an angle greater than 90 degrees or greater than 105 degrees or greater than 115 degrees. For example, the first adjustment direction 207A and the second adjustment direction 207B intersect at an angle of 120 degrees.

Preferably, the second adjustment mechanism 206B is designed in correspondence to the first adjustment mechanism 206A, so that the explanations relating to the first adjustment mechanism 206A apply in correspondence to the second adjustment mechanism 206B. For example, the second adjustment mechanism 206B is designed to be mirror-symmetrical with respect to the first adjustment mechanism 206A, in particular with respect to an axis running parallel to the x-direction. Expediently, each adjustment mechanism 206A, 206B comprises its own actuating element 215A, 215B.

In an x-y view, the adjustment directions 207A, 207B expediently form a V-shape. In FIG. 17, the two adjustment mechanisms 206A, 206B are set differently for illustrative purposes. Both adjustment mechanisms 206A, 206B can be set differently or the same, so that the connecting elements of the two shoulder joint arrangements 9A, 9B can expediently be extended differently or the same distance from the back part 8.

Expediently, the width markings of the second adjustment mechanism 206B correspond to the width markings of the first adjustment mechanism 206A. In particular, the same width markings of the first adjustment mechanism 206A and the second adjustment mechanism 206B have the same distance from the sagittal plane of the exoskeleton. In this way, the shoulder joint arrangement 9 can be easily adjusted to the shoulder width of the user.

As shown by way of example in FIG. 4, the support section 3, in a position with its support section longitudinal axis 261 directed maximally downwards, in particular at a minimum pivot angle 47, is with its support section longitudinal axis 261 directed laterally outwards with respect to a vertical axis 262 of the exoskeleton 20 by an angle, in particular an abduction angle, greater than zero in the width direction y of the exoskeleton 20, so that a distance in the width direction y between the support section longitudinal axis 261 and the vertical axis 262 increases in the vertically downward direction. The support section longitudinal axis 261 is preferably equal to the support section axis 61 and/or the vertical axis 262 is expediently equal to the base section axis 62.

The angle, in particular the abduction angle, is expediently between 5 and 10 degrees, for example 5 degrees. The angle corresponds appropriately to the human abduction angle. In particular, the human abduction angle is the angle at which the upper arm protrudes from the vertical body axis when the arm is hanging loosely downwards.

Expediently, the first support section 3A and the second support section 3B are each directed outwards with their respective support section axis 261 as explained above. The longitudinal axes 261 of the two support sections 3A, 3B expediently have twice the abduction angle, for example 10 degrees, to one another in the y-z plane.

Preferably, the joint chain 201 does not have a degree of freedom that enables pure abduction of the arm 4. Preferably, abduction of the arm during use of the exoskeleton 20 can be achieved by a combined flexion and rotation movement of the arm 4.

With reference to FIGS. 13 and 14, a stowage configuration that can be adopted by the exoskeleton 20 will be described in more detail below.

Preferably, the exoskeleton 20 can be moved selectively into a stowage configuration or an operating configuration by folding the shoulder joint arrangement 9 relative to the base section 1 and/or by moving the force transmission element 18 arranged on the base section 1, in particular leading to the pelvic strap 16. The exoskeleton 20 is more compact in the stowage configuration, and in particular has a smaller width and/or height than in the operating configuration. Expediently, the exoskeleton 20 is not intended to be worn by a user as an exoskeleton 20 in the stowage configuration.

Preferably, the support sections 3 are folded over the back part 8 at the front in the stowage configuration. Furthermore, in the stowage configuration, the force transmission element 18 is preferably pushed as far as possible into the back part 8.

FIG. 14 shows the exoskeleton 20 in the stowage configuration. As an example, the exoskeleton 20 is arranged in a container 216, which is designed, for example, as a system box or a suitcase. Preferably, the exoskeleton 20 fits into the container 216 in the stowage configuration and/or does not fit into the container 216 in the operating configuration. Preferably, an arrangement is provided comprising the container 216 and the exoskeleton 20 accommodated in the container 216, wherein the exoskeleton 20 expediently is in the stowage configuration.

For reasons of better visualization, the support section 3 is not shown in FIG. 13. By way of example, in the stowage configuration the joint chain 201, in particular the first main joint element 211 and/or the second main joint element 212, is pivoted inwards relative to the back part 8 (about an imaginary vertical axis and/or about the first vertical main axis of rotation 241), in particular pivoted further inwards than in the second end position shown, for example, in FIG. 11. Preferably, the lifting pivot bearing 34 is located in the same y-range as the back part 8 in the stowage configuration and/or is located outside the y-range of the back part 8 in the operating configuration.

As shown as an example in FIG. 14, both shoulder joint arrangements 9 are expediently folded forward in the stowage configuration, so that both support sections 3A, 3B are positioned in front of the back part 8 and at least partially overlap the back part in the y-direction.

Preferably, the exoskeleton 20 comprises a locking mechanism 208 that locks the exoskeleton 20 in the operating configuration such that unlocking of the locking mechanism 208 is required to move the exoskeleton 20 to the stowage configuration. In particular, the locking mechanism 208 locks the shoulder joint arrangement 9 of the exoskeleton 20 in the operating configuration, thereby preventing the shoulder joint arrangement 9 from folding over into the stowage configuration.

As explained above, the shoulder joint arrangement 9 comprises the first auxiliary pivot bearing 231, the second auxiliary pivot bearing 232, and the first auxiliary joint element 213 extending from the first auxiliary pivot bearing 231 to the second auxiliary pivot bearing 232. By way of example, the first auxiliary joint element 213 can be extended and/or decoupled by unlocking the locking mechanism 208 in order to enable the shoulder joint arrangement 9 to be folded over relative to the base section 1, in particular relative to the back part 8.

In particular, by unlocking the locking mechanism 208, the kinematic relationship between the inner shoulder joint section 27 formed, for example, by the first quadrilateral and the outer shoulder joint section 28 formed, for example, by the second quadrilateral can be decoupled.

As shown in FIG. 13, the first auxiliary joint element 213 expediently comprises a first joint element section 217 (in particular associated with the first auxiliary pivot bearing 231) and a second joint element section 218 (in particular associated with the second auxiliary pivot bearing 232), which are movable relative to one another by unlocking the locking mechanism 208 in order to extend the first auxiliary joint element 213, in particular in the longitudinal direction of the first auxiliary joint element 213, and preferably thereby enable the shoulder joint arrangement 9, in particular the outer shoulder joint section 28, to be folded over in front of the back part 8.

In an exemplary embodiment, one of the joint element sections 217, 218 is at least partially insertable into and extendable from the other of the joint element sections 217, 218 to selectively lengthen or shorten the first auxiliary joint element 213.

Alternatively, an embodiment may be provided in which the joint element sections 217, 218 can be pulled apart to such an extent that they are completely decoupled from one another.

Preferably, the locking mechanism 208 comprises an actuating element 219 via which the locking mechanism 208 can be selectively locked or unlocked by the user. In particular, the two joint element sections 217, 218 can be selectively fixed relative to one another or made displaceable relative to one another by means of the actuating element 219. As an example, the actuating element 219 is arranged on the first cover cap 271. Preferably, a detent element, in particular a detent pin, can be moved by means of the actuating element 219, by means of which the fixation of the two joint element sections 217, 218 relative to one another can be selectively produced or released.

Preferably, the exoskeleton 20 further comprises a force transmission element locking mechanism 235 which locks the force transmission element 18 in the operating configuration and thus prevents the force transmission element 18 from moving into the stowed configuration. In particular, the force transmission element locking mechanism 235 is designed to selectively fix the force transmission element 18 relative to the back part 8 or to make it displaceable, in particular insertable and extendable.

FIG. 15 shows an exemplary embodiment of the container 216 designed as a system box. The container 216 comprises a lower part 227, a lid 228 placed on the lower part 227 and coupling elements 229 for coupling the container 216 to an upper container 224 placed on the container 216 and identical to the container 216 and/or for coupling the container 216 to a lower container 225 which is identical to the container 216 and on which the container 216 is placed.

The coupling elements 229 comprise one or more latches, in particular rotary latches, one or more protrusions and/or one or more recesses.

FIG. 16 shows a vertical stack 226 consisting of the lower container 225, the container 216 placed on the lower container 225 and the upper container 224 placed on the container 216. The containers 225, 216, 224 are fixed to each other via the coupling elements 229, in particular in all spatial directions. For example, the entire stack 226 can be lifted by lifting the upper container 224.

Expediently, the exoskeleton 20 can also be provided with a different shoulder joint arrangement, for example a shoulder joint arrangement without a joint chain or without a joint chain that provides a movement path, in particular a curved movement path, for the lifting pivot bearing. For example, the joint chain can define more than one degree of freedom for the movement of the lifting pivot bearing, for example a movement in a plane of movement, in particular a movement with two or more degrees of freedom.

1. An exoskeleton, comprising:
a base section for attachment to a torso of a human body,
a support section for supporting an arm of the human body,
an actuator device acting on the support section for providing a support force for the arm, and
a shoulder joint arrangement via which the support section is movably coupled to the base section, wherein
the shoulder joint arrangement comprises a lifting pivot bearing, via which the support section is mounted on the shoulder joint arrangement so as to be pivotable about a horizontal lifting axis, and
the shoulder joint arrangement further comprises a joint chain which defines a curved movement path for the lifting pivot bearing, relative to the base section.

2. The exoskeleton according to claim 1, wherein the movement path has a curvature changing along the movement path, so that the movement path is not circular.

3. The exoskeleton according to claim 1, wherein the joint chain is designed to pivot the lifting pivot bearing about an imaginary vertical axis of rotation extending through the lifting pivot bearing as a function of a path position of the lifting pivot bearing on the movement path, so that, by performing a movement of the lifting pivot bearing along the movement path, the support section can be pivoted horizontally with respect to the base section.

4. The exoskeleton according to claim 1, wherein the joint chain is designed to guide the lifting pivot bearing on the movement path in such a way that the lifting axis is aligned along the movement path correspondingly to a horizontal shoulder joint axis of a shoulder of a user wearing the exoskeleton.

5. The exoskeleton according to claim 1, wherein a movement along the movement path during operation of the exoskeleton is the only degree of freedom for positioning the lifting pivot bearing relative to the base section.

6. The exoskeleton according to a claim 1, wherein the exoskeleton defines a free space which, in the worn state of the exoskeleton, is located above the shoulder of the user wearing the exoskeleton and around which the joint chain extends, so that the user can direct his arm supported by the support section upwards through the free space past the joint chain.

7. The exoskeleton according to claim 1, wherein the joint chain comprises a first main joint element, a first auxiliary joint element, a second main joint element, a second auxiliary joint element and a shoulder part comprising the lifting pivot bearing, as well as a first main pivot bearing, via which the first main joint element is rotatably mounted relative to the base section, a first auxiliary pivot bearing, via which the first auxiliary joint element is rotatably mounted relative to the base section, a second main pivot bearing, via which the second main joint element is rotatably mounted on the first main joint element, a second auxiliary pivot bearing, via which the second main joint element is rotatably mounted on the first auxiliary joint element, a third auxiliary pivot bearing, via which the second auxiliary joint element is rotatably mounted on the first main joint element, a third main pivot bearing via which the shoulder part is rotatably mounted on the second main joint element, and a fourth auxiliary pivot bearing via which the shoulder part is rotatably mounted on the second auxiliary joint element.

8. The exoskeleton according to claim 7, wherein the axes of rotation of the second main pivot bearing, the third main pivot bearing, the third auxiliary pivot bearing and the fourth auxiliary pivot bearing lie on corners of an imaginary quadrilateral which is not a parallelogram.

9. The exoskeleton according to claim 7, wherein
a ratio of a distance between the rotational axes of the second main pivot bearing and the third main pivot bearing to a distance between the rotational axes of the second main pivot bearing and the first main pivot bearing is between 0.75 and 1, and/or
a ratio of a distance between the rotational axes of the second main pivot bearing and the second auxiliary pivot bearing to a distance between the rotational axes of the first main pivot bearing and the first auxiliary pivot bearing is 1, and/or
a ratio of a distance between the rotational axes of the second main pivot bearing and the second auxiliary pivot bearing to a distance between the rotational axes of the third main pivot bearing and the fourth auxiliary pivot bearing is 1, and/or
a ratio of a distance between the rotational axes of the second main pivot bearing and the second auxiliary pivot bearing to a distance between the rotational axes of the second main pivot bearing and the third auxiliary pivot bearing is between 0.85 and 1, and/or
a ratio of the distance between the axes of rotation of the first main pivot bearing and the second main pivot bearing to a distance between the axes of rotation of the first auxiliary pivot bearing and the second auxiliary pivot bearing is 1, and/or
a ratio of the distance between the axes of rotation of the second main pivot bearing and the third main pivot bearing to a distance between the axes of rotation of the third auxiliary pivot bearing and the fourth auxiliary pivot bearing is between 0.9 and 1.

10. The exoskeleton according to claim 7, wherein the first main joint element and/or the second auxiliary joint element are arranged vertically offset to the second main joint element, so that the joint chain is displaceable into a fold-in position, in which a pivot angle between the first main joint element and the second main joint element is minimal and the first main joint element and/or the second auxiliary joint element overlaps horizontally with the second main joint element with more than half of the respective longitudinal extension and/or the first main pivot bearing is located directly next to the third main pivot bearing.

11. The exoskeleton according to claim 1, further comprising an adjustment mechanism via which the shoulder joint arrangement can be positioned in an adjustment direction relative to the base section in order to adapt the exoskeleton to a shoulder width of the user.

12. The exoskeleton according to claim 11, wherein the shoulder joint arrangement is a first shoulder joint arrangement, the adjustment mechanism is a first adjustment mechanism and the adjustment direction is a first adjustment direction, and wherein the exoskeleton further comprises a second shoulder joint arrangement and a second adjustment mechanism, via which the second shoulder joint arrangement can be positioned in a second adjustment direction relative to the base section, wherein the first adjustment direction and the second adjustment direction intersect at an obtuse angle.

13. The exoskeleton according to claim 1, wherein the exoskeleton is selectively movable into a stowage configuration or an operating configuration by folding the shoulder joint arrangement relative to the base section and/or by moving a force transmission element arranged on the base section and leading in particular to a pelvic strap of the exoskeleton, wherein the exoskeleton is more compact in the stowage configuration and has a smaller width and/or height than in the operating configuration and cannot be put on as an exoskeleton by a user as intended in the stowage configuration.

14. The exoskeleton of claim 13, further comprising a locking mechanism that locks the exoskeleton in the operating configuration such that unlocking the locking mechanism is required to place the exoskeleton in the stowage configuration.

15. The exoskeleton according to claim 13, wherein the locking mechanism locks the shoulder joint assembly of the exoskeleton in the operating configuration, thereby preventing the shoulder joint assembly from folding over into the stowage configuration.

16. The exoskeleton according to claim 14, wherein the shoulder joint arrangement comprises a first auxiliary pivot bearing, a second auxiliary pivot bearing, and a first auxiliary joint element extending from the first auxiliary pivot bearing to the second auxiliary pivot bearing, and wherein, by unlocking the locking mechanism, the first auxiliary joint element can be extended and/or decoupled in order to enable the shoulder joint arrangement to be folded over relative to the base section.

17. The exoskeleton according to claim 13, further comprising a force transmission element locking mechanism that locks the force transmission element in the operating configuration and thus prevents the force transmission element from moving to the stowage configuration.

18. The exoskeleton according to claim 1, wherein the support section, in a position with its support section longitudinal axis directed maximally downwards, is oriented with its support section longitudinal axis laterally outwards relative to a vertical axis of the exoskeleton by an angle greater than zero in the width direction of the exoskeleton, so that a distance in the width direction between the support section longitudinal axis and the vertical axis increases in the vertically downward direction.

19. A method for operating an exoskeleton according to claim 1, comprising the step of: moving the lifting pivot bearing along the movement path relative to the base section.

20. The exoskeleton according to claim 1, wherein the curved movement path lies in a horizontal plane.

21. The exoskeleton according to claim 1, wherein the joint chain is designed to guide the lifting pivot bearing on the movement path in such a way that the lifting axis is aligned along the entire movement path coaxially to a horizontal shoulder joint axis of a shoulder of a user wearing the exoskeleton.

22. The exoskeleton according to claim 8, wherein the imaginary quadrilateral is an irregular quadrilateral.
